(19) United States
(12) Patent Application Publication
(10) Pub. No.: US 2026/0188593 A1
(43) Pub. Date: Jul. 2, 2026

(54) MULTILAYER CERAMIC ELECTRONIC COMPONENT AND MANUFACTURING METHOD OF THE SAME

(71) Applicant: TAIYO YUDEN CO., LTD., Tokyo (JP)

(72) Inventors: Kazuki KAWAI, Takasaki-shi (JP); Kenji TAKASHIMA, Takasaki-shi (JP); Mika NISHIZAWA, Takasaki-shi (JP); Kazuho MURATA, Takasaki-shi (JP)

(21) Appl. No.: 19/549,620

(22) Filed: Feb. 25, 2026

Related U.S. Application Data
(63) Continuation of application No. PCT/JP2024/027126, filed on Jul. 30, 2024.

(30) Foreign Application Priority Data
Sep. 29, 2023 (JP) 2023-170332

(51) Int. Cl. H01G 4/30; H01G 4/12

(52) U.S. Cl. CPC H01G 4/30; H01G 4/1245

(57) ABSTRACT

A multilayer ceramic electronic component includes an element body, the element body including a capacitor section in which first and second internal electrode layers are alternately laminated with a dielectric layer interposed therebetween and protective regions of the capacitor section; and external electrodes provided on surfaces of the element body, the first and second internal electrode layers being drawn out from the surfaces, wherein each of the dielectric layer and the protective regions contains a dielectric ceramic as a main component, each of the protective regions includes a first layer adjacent to the capacitor section, a second layer adjacent to the first layer, and a third layer adjacent to the second layer, an atomic ratio of Mn in the second layer is larger than that in the first layer, and a content of a glass component of the second layer is larger than those of the first and third layer.

### CROSS-REFERENCE TO RELATED APPLICATION

This application is a continuation application of PCT/JP2024/027126 filed on Jul. 30, 2024, which claims priority of Japanese Patent Application No. 2023-170332 filed on Sep. 29, 2023, the entire contents of which are incorporated herein by reference.

### FIELD

A certain aspect of the present disclosure relates to a multilayer ceramic electronic component and a manufacturing method of the same.

### BACKGROUND

A multilayer ceramic electronic component having a multilayer body (a capacitor section) in which internal electrodes and dielectric layers are alternately laminated and having a protective region around the multilayer body is known. The protective region includes a side margin portions formed on side surfaces of the multilayer body and cover portions provided on main surfaces of the multilayer body positioned at both ends in a lamination direction of the dielectric layer. The side margin portions are sometimes referred to as side layers. The cover portions are sometimes referred to as main surface layers. There is a conventionally proposed structure in which the main surface layers and side surface layers are respectively formed of a plurality of layers (Refer to, for example, Japanese Examined Patent Publication No. 2021-072356.).

### SUMMARY OF THE INVENTION

According to a first aspect of the present disclosure, there is provided a multilayer ceramic electronic component including: an element body having a substantially rectangular parallelepiped shape, the element body including a capacitor section in which first internal electrode layers and second internal electrode layers are alternately laminated with a dielectric layer interposed therebetween and protective regions provided outside of the capacitor section; and external electrodes provided on surfaces of the element body respectively so as to be spaced from each other, the first internal electrode layers and the second internal electrode layers being respectively drawn out from the surfaces, wherein each of the dielectric layer and the protective regions contains a dielectric ceramic as a main component, each of the protective regions includes a first layer adjacent to the capacitor section, a second layer adjacent to the first layer, and a third layer adjacent to the second layer, the first layer, the second layer, and the third layer being sequentially disposed on the capacitor section, an atomic ratio of Mn in the second layer is larger than that in the first layer, and a content of a glass component of the second layer is larger than that of the first layer and that of the third layer.

According to a second aspect of the present disclosure, there is provided a manufacturing method of a multilayer ceramic electronic component, including: forming a multilayer body as a capacitor section in which first internal electrode layers and second internal electrode layers are alternately laminated with a dielectric layer interposed therebetween; forming an element body by providing the multilayer body with protective regions having a first layer adjacent to surfaces of the multilayer body where the first internal electrode layers and the second internal electrode layers are exposed, a second layer adjacent to the first layer, and a third layer adjacent to the second layer; firing the element body; forming external electrodes on the element body after the firing, wherein each of the dielectric layer and the protective regions contains a dielectric ceramic as a main component, an atomic ratio of Mn in the second layer is larger than that in the first layer, and a content of a glass component of the second layer is larger than that of the first layer and that of the third layer.

### BRIEF DESCRIPTION OF THE DRAWINGS

FIG. 1 is a perspective view of a multilayer ceramic capacitor according to the first embodiment of the present invention.

FIG. 2 is a sectional view of the multilayer ceramic capacitor taken along a line A-A′ in FIG. 1.

FIG. 3 is a sectional view of the multilayer ceramic capacitor taken along a line B-B′ in FIG. 1.

FIG. 4 is an partially enlarged sectional view of side margins of the multilayer ceramic capacitor according to the first embodiment.

FIG. 5 is a flowchart illustrating an example of a method of manufacturing the multilayer ceramic capacitor.

FIG. 6 is a perspective view of the multilayer ceramic capacitor in progress of a manufacturing process according to the first embodiment.

FIG. 7 is a perspective view of the multilayer ceramic capacitor in progress of the manufacturing process according to the first embodiment.

FIGS. 8A to 8C are sectional views of the multilayer ceramic capacitor in progress of the manufacturing process according to the first embodiment.

FIG. 9 is a perspective view of the multilayer ceramic capacitor in progress of the manufacturing process according to the first embodiment.

FIG. 10 is a sectional view of a multilayer ceramic capacitor of the second embodiment cut along a cutting line corresponding to the line A-A′ in FIG. 1.

FIG. 11 is a schematic sectional view of the multilayer ceramic capacitor of the second embodiment in progress of a manufacturing process.

### DETAILED DESCRIPTION

The protective region has a function of protecting the multilayer body. When the protective region is provided around the multilayer body, an element can be added so as to particle growth of the protective region is suppressed, thus securing reliability of the protective portion. However, an addition of the element that suppresses particle growth may, on the other hand, inhibit particle growth of dielectrics within the capacitor region. If the particle growth of the dielectrics of the capacitor region is inhibited, a dielectric constant of the multilayer body turning to be the capacitor region is lowered, thus decreasing an effective capacitance. Therefore, the protective region is required to improve reliability of the ceramic electronic component while ensuring the effective capacitance of the ceramic electronic component. The conventionally proposed structure shown in Japanese Examined Patent Publication No. 2021-072356 has room for improvement in terms of the above requirements for the protection region.

### First Embodiment

The first embodiment of the present invention will be described below with reference to the drawings. In the drawings, X-axis, Y-axis, and Z-axis s are shown which are orthogonal to each other. The X-axis, the Y-axis, and the Z-axis are common to all the drawings.

### Overall Configuration of Multilayer Ceramic Capacitor 10

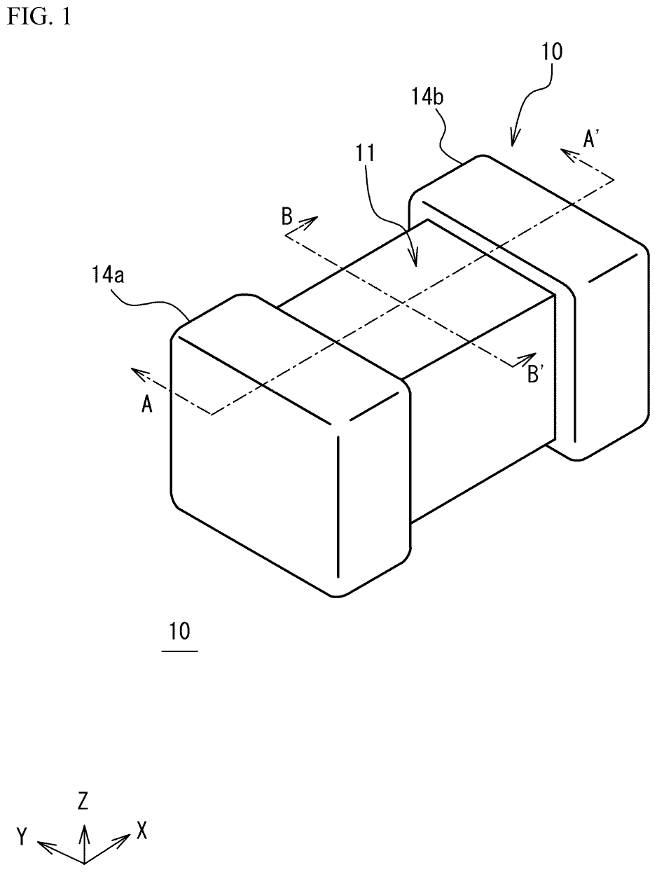

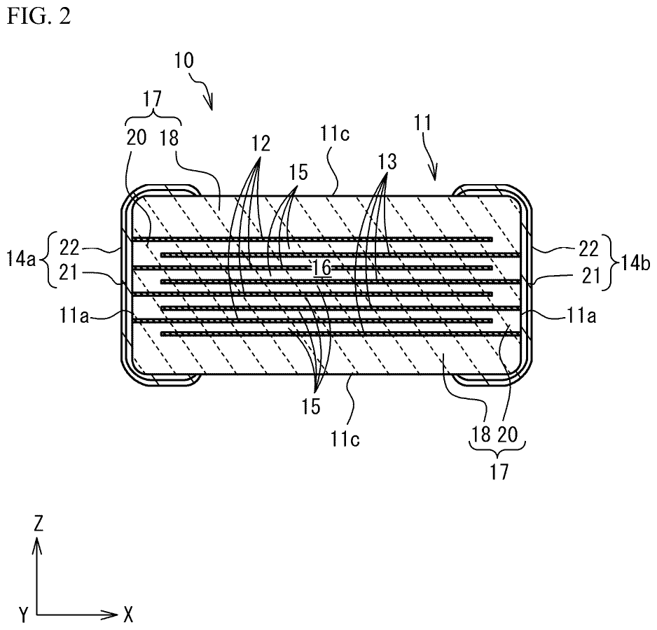

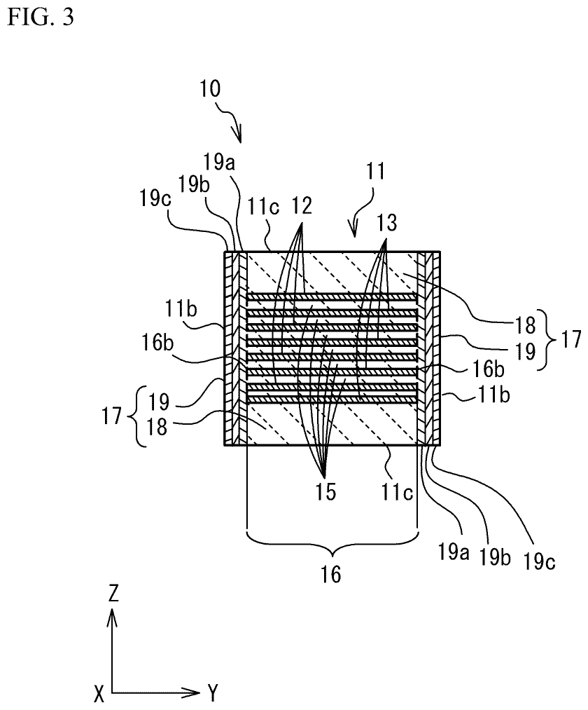

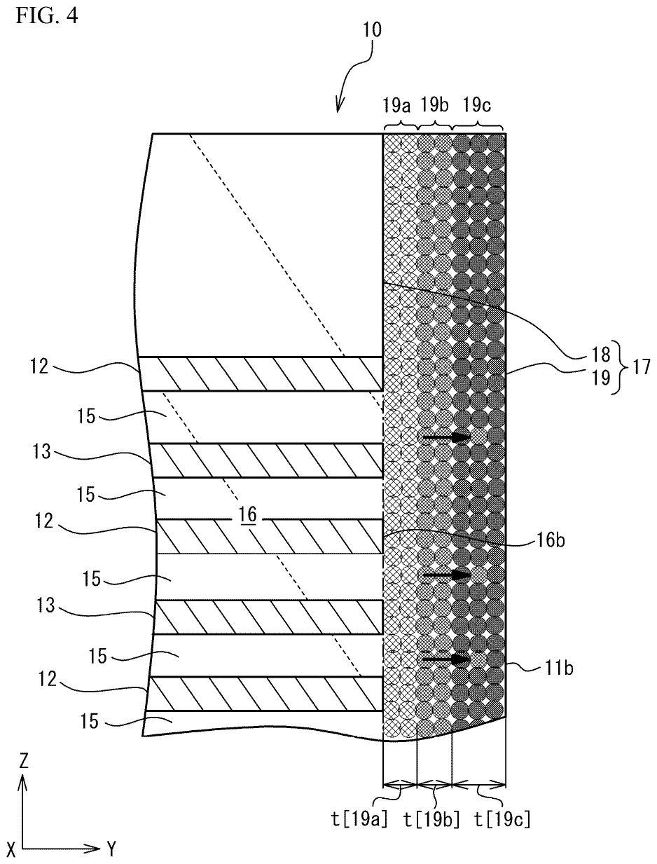

FIGS. 1 to 4 are views illustrating the multilayer ceramic capacitor 10 according to the first embodiment of the present invention. FIG. 1 is a perspective view of the multilayer ceramic capacitor 10 according to the first embodiment of the present invention. FIG. 2 is a sectional view of the multilayer ceramic capacitor 10 taken along a line A-A′ in FIG. 1. FIG. 3 is a sectional view of the multilayer ceramic capacitor 10 taken along a line B-B′ in FIG. 1. FIG. 4 is an partially enlarged sectional view of side margins 19 of the multilayer ceramic capacitor 10 according to the first embodiment.

As illustrated in FIGS. 1 to 4, the multilayer ceramic capacitor 10 includes an element body 11 having a substantially rectangular parallelepiped shape. In the element body 11, four surfaces other than an upper surface and a lower surface in a stacking direction are referred to as side surfaces. In the element body 11, a first external electrode 14a and a second external electrode 14b are provided on two opposing side surfaces (a first side surface and a second side surface), respectively. The first external electrode 14a extends from the first side surface to four adjacent surfaces. The second external electrode 14b extends from the second side surface to four adjacent surfaces. However, the first external electrode 14a and the second external electrode 14b are spaced apart from each other.

Additionally, in FIGS. 1 to 3, the Z-axis direction (first direction) is a lamination direction, and is a direction in which internal electrode layers face each other. The X-axis direction (second direction) is a length direction of the element body 11, in which the first side surface and the second side surface of the element body 11 face each other, and in which the first external electrode 14a and the second external electrode 14b face each other. The Y-axis direction (third direction) is a width direction of the internal electrode layers, and is a direction in which two side surfaces (third side surface and fourth side surface) other than the first side surface and the second side surface among the four side surfaces of the element body 11 face each other. The X-axis direction, the Y-axis direction, and the Z-axis direction are perpendicular to each other.

The element body 11 has a structure in which dielectric layers 15 containing a ceramic material functioning as a dielectric and the internal electrode layers are alternately laminated. The internal electrode layers include a plurality of first internal electrode layers 12 and a plurality of second internal electrode layers 13. The first internal electrode layers 12 and the second internal electrode layers 13 are alternately laminated with the dielectric layer 15 interposed therebetween. Edges of the first internal electrode layers 12 are drawn out to the first side surface of the element body 11 where the first external electrode 14a is provided. Edges of the second internal electrode layers 13 are drawn out to the second side surface of the element body 11 where the second external electrode 14b is provided. Thus, the first internal electrode layer 12 and the second internal electrode layer 13 are alternately connected to the first external electrode 14a and the second external electrode 14b respectively. As a result, the multilayer ceramic capacitor 10 has a structure in which capacitance units are laminated. In a multilayer body of the dielectric layers 15 and the first and second internal electrode layers 12 and 13, the first and second internal electrode layer 12 and 13 are disposed on an outermost layer in the lamination direction, and the upper surface and the lower surface of the multilayer body are covered with cover portions 18. The cover portions 18 are mainly composed of a ceramic material. The multilayer ceramic capacitor 10 is not limited to the configuration of FIGS. 1 to 3 as long as the first internal electrode layers 12 and the second internal electrode layers 13 are exposed to different regions of the surfaces of the multilayer body and are electrically connected to different external electrodes. The different regions of the surfaces of the multilayer body may be respective surface regions of opposing surfaces of the multilayer body or respective surface regions of adjacent surfaces of the multilayer body, or the different surface regions of the same surface of the multilayer body. The different external electrodes may respectively extend from the surfaces where the first internal electrode layers 12 and the second internal electrode layers 13 are exposed to reach other surface regions of the multilayer body as long as they are spaced apart from each other.

The size of the multilayer ceramic capacitor 10 is, for example, a length of 0.25 mm, a width of 0.125 mm, and a height of 0.125 mm, or a length of 0.4 mm, a width of 0.2 mm, and a height of 0.2 mm, or a length of 0.6 mm, a width of 0.3 mm, and a height of 0.3 mm, or a length of 1.0 mm, a width of 0.5 mm, and a height of 0.5 mm, or a length of 3.2 mm, a width of 1.6 mm, and a height of 1.6 mm, or a length of 4.5 mm, a width of 3.2 mm, and a height of 2.5 mm, but is not limited to these sizes. The size of the multilayer ceramic capacitor 10 may be, for example, length>width≥height, width>length≥height, height>length≥width, or height>width≥length.

The element body 11 has a capacitor section 16 and protective regions 17, and the capacitor section 16 is a multilayer body of the dielectric layers 15, the first internal electrode layers 12, and the second internal electrode layers 13. The protective regions 17 constitute a peripheral edge portion of the element body 11 and has two side surfaces facing each other in the X-axis direction, two side surfaces 11b facing each other in the Y-axis direction, and two main surfaces 11c facing each other in the Z-axis direction. The two side surfaces facing each other in the X-axis direction are sometimes referred to end surfaces 11a. The side surface 11b and the main surface 11c constitute a plurality of peripheral surfaces. The end surface 11a, the side surface 11b and the main surface 11c are formed of, for example, substantially flat surfaces, but may be rounded.

The protective regions 17 has cover portions 18, side margins 19, and end margins 20. The cover portions 18 are outer regions of the capacitor section 16 in the lamination direction. The side margins 19 are outer regions of the capacitor section 16 in a perpendicular direction to the lamination direction, and are regions where the first internal electrode layers 12 and the second internal electrode layers 13 are not drawn out to the surface of the element body 11. The end margins 20 are outer regions of the capacitor section 16 in a perpendicular direction to the lamination direction, and are regions where at least one of the first internal electrode layer 12 and the second internal electrode layer 13 is drawn out to the surface of the element body 11.

More specifically, in the configuration of FIGS. 1 to 3, the cover portions 18 are located outside the capacitor section 16 in the Z-axis direction. The side margins 19 are located outside the capacitor section 16 in the Y-axis direction. The end margins 20 are located outside the capacitor section 16 in the X-axis direction. In FIGS. 1 to 3, the lamination direction is the Z direction of the element body 11. Even when the lamination direction is the X direction or the Y direction, the cover portions 18, the side margins 19, and the end margins 20 included in the protective regions 17 can be defined as appropriate.

The capacitor section 16 is disposed inside the protective regions 17 and constitutes a functional portion. The capacitor section 16 includes a plurality of the first internal electrode layers 12 and a plurality of second internal electrode layers 13 which are laminated with the dielectric layer 15 interposed therebetween (see FIG. 2). In the configuration of FIGS. 1 to 3, the capacitor section 16 is laminated in the Z-axis direction. The internal electrode layers 12 and 13 are formed as sheet shapes extending in a direction perpendicular to the lamination direction, that is, along the X-Y plane of the configuration of FIGS. 1 to 3, and are alternately arranged along the Z-axis direction. The structure of the dielectric layers 15 are described in detail later.

The first internal electrode layers 12 and the second internal electrode layers 13 are mainly composed of a base metal such as nickel (Ni), copper (Cu), or tin (Sn), or an alloy containing these metals. As the main components of the first internal electrode layers 12 and the second internal electrode layers 13, precious metals such as platinum (Pt), palladium (Pd), silver (Ag), and gold (Au), and alloys containing these metals may be used. The main component of the first internal electrode layers 12 and the main component of the second internal electrode layers 13 may be the same or different. When there is no need to distinguish between the first internal electrode layers 12 and the second internal electrode layers 13, the first internal electrode layers 12 and the second internal electrode layers 13 may be collectively referred to as internal electrodes.

The dielectric layer 15 has, for example, a ceramic material having a perovskite structure represented by a general formula ABO₃ as a main phase. The perovskite structure contains ABO_{3-α}that is not in the stoichiometric composition (0≤α≤1: α represents an amount that is not in the stoichiometric composition; hereinafter, α is omitted). For example, the ceramic material can be selected from at least one of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming a perovskite structure. Ba_{131 x-y}CaₓSr_{y}Ti_{1-z}Zr_{z}O₃ is barium strontium titanate, barium calcium titanate, barium zirconate, barium zirconate titanate, calcium zirconate titanate, barium calcium zirconate titanate, and the like. For example, the dielectric layers 15 contain 50 at % or more of the main component ceramic, and for example, 90 at % or more of the main component ceramic may be contained. The thicknesses of the dielectric layers 15 are, for example, 5.0 μm or less, 3.0 μm or less, 1.0 μm or less, 0.5μm or less, 0.4 μm or less, 0.3 μm or less, and 0.2 μm or less. The thicknesses of the dielectric layers 15 can be measured by observing the cross section of the multilayer ceramic capacitor 10 with a scanning electron microscope (SEM), measuring the thickness of each of ten different dielectric layers 15 at ten points, and deriving the average value of all the measurement points.

Additives may be added to the dielectric layers 15. The additives to the dielectric layers 15 include an oxide of zirconium (Zr), magnesium (Mg), manganese (Mn), molybdenum (Mo), vanadium (V), chromium (Cr), a rare earth element (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm) or ytterbium (Yb)), or an oxide including cobalt (Co), nickel (Ni), lithium (Li), boron (B), sodium (Na), potassium (K) or silicon (Si), or a glass including cobalt, nickel, lithium, boron, sodium, potassium or silicon.

The protective regions 17 are also formed of a dielectric ceramic. In the protective regions 17, the end margins 20 preferably have the same composition as the main component of the dielectric layers 15 in the viewpoint of suppression of the internal stress. In the present embodiment, the cover portions 18 also have the same composition as the main component of the dielectric layer 15. This improves the manufacturing efficiency.

Since the cover portions 18 and the side margins 19 of the protective regions 17 do not include an internal electrode, the density of the cover portions 18 and the side margins 19 after pressure bonding is likely to be lower than that of the capacitor section 16. Also, the cover portions 18 and the side margins 19 are hardly affected by sintering of the metal elements contained in the internal electrodes during the firing. The end margins 20 of the protective regions 17 includes lead portions of the internal electrode layers 12 and the internal electrode layers 13 as a part thereof. But proportion of the end margins 20 are small as compared with the capacitor section 16, and therefore, the density of the end margins 20 after compression bonding is likely to be lower than that of the capacitor section 16 at the time of the compression bonding. In addition, the influence to the capacitor section 16 from the metal elements contained in the lead portions of the internal electrodes during the firing is limited. As described above, the density of the protective regions 17 is not easily increased by the firing, and a difference between the density of the protective regions 17 and that of the capacitor section 16 is generated after the firing. Therefore, the mechanical strength of the protective regions 17 is liable to be lowered, and thus peeling and cracking are liable to occur. Additionally, moisture from the outside is liable to enter the protective regions 17 because the protective regions 17 are not dense, and the lives thereof may be reduced. In order to prevent this deterioration of the reliability, elements for promoting the firing are added to the protective regions 17.

The side margins 19 of the protective regions 17 have the same main component as the dielectric layers 15. In the present invention, the side margins 19 respectively include a first layer 19a, a second layer 19b, and a third layer 19c as illustrated in FIGS. 3 and 4. The first layer 19a is adjacent to the side surface 11b of the capacitor section 16 facing the Y-axis direction. The second layer 19b is adjacent to the first layer 19a. The third layer 19c is adjacent to the second layer 19b. The first layer 19a, the second layer 19b, and the third layer 19c are sequentially disposed on the capacitor section 16.

The first layer 19a is formed with a small density difference from the dielectric layers 15 and has a function of having no influence on the particle growth of the dielectric on the first layer 19a side in the dielectric layers 15.

The second layer 19b is an intermediate layer having a function of connecting a layer in which the particle growth of the dielectric material on the first layer 19a side is suppressed and a layer in which the particle growth of the dielectric material on the first layer 19a side is promoted without any inconsistency.

The third layer 19c is a layer in which the particle growth of the dielectric is promoted. The third layer 19c also has a function of improving moisture resistance.

In order to realize functions described above, the first layer 19a, the second layer 19b, and the third layer 19c are layers having the same main components as the dielectric layer of the capacitor section 16 and different auxiliary components or different additional components.

Specifically, the first layer 19a can be defined as a layer in which a total concentration (atomic %) of magnesium (Mg), ytterbium (Yb), and erbium (Er) is greater than a concentration (atomic %) of Mn. Alternatively, the first layer 19a can be more specifically defined as a layer satisfying a condition that ((Ba+Sr+Ca)/(Ti+Zr+Hf) ) is less than 0.96 or a condition that ((Ba+Sr+Ca)/(Ti+Zr+Hf) ) is 1.02 or more, where the ratio of the numbers of atoms in the A site and the B site of the perovskite structure in the dielectric, that is, an A/B ratio is defined as ((Ba+Sr+Ca)/(Ti+Zr+Hf)).

The second layer 19b can be defined as a layer in which a concentration (atomic %) of Mn is higher than a total concentration (atomic%) of Mg, Yb, and Er, and the concentration (atomic %) of Mn is higher than a total concentration (atomic %) of Mo, B, and Si.

The third layer 19c can be defined as a layer in which a total concentration (atomic %) of Mo, B, and Si is greater than a concentration (atomic %) of Mn.

The second layer 19b and the third layer 19c may contain a glass component, and the concentrations of the glass component (concentration of a portion where Si and B exist simultaneously: atom %) in the first layer 19a, second layer 19b, and third layer 19c may be in the following order: second layer 19b >third layer 19c >first layer 19a.

The first layer 19a is formed with a small density difference from the dielectric layers 15 and has a function of having no influence on the particle growth of the dielectric on the first layer 19a side of the dielectric layers 15. In order to have such a function, in the first aspect of the present invention, the first layer 19a can contain, in addition to the same main components as those of the dielectric layers 15, elements which are less diffused into the dielectric layers 15 during the firing while the densification of the first layer 19a is promoted. The element having no influence the particle growth of the dielectric layers 15 while densifying the first layer 19a is an element which, in promoting the firing of the first layer 19a, increases the density of the first layer 19a and eliminates the density difference from the dielectric layers 15 by promoting the formation of fine particles without causing significant particle growth, and which is difficult to diffuse during the firing. Since the diffusion of the element into the dielectric layer 15 during the firing is small, the influence of the diffusion of the element into the first layer 19a side of the dielectric layers 15, which occurs in the conventional art, on the particle growth of the dielectric layer 15 is suppressed.

Examples of such elements include elements selected from Mg, Yb, and Er, but other elements may be used, and one or more of these elements may be appropriately added. In order to have such a function, in the second embodiment of the present invention, the first layer 19a is formed by satisfying the condition that ((Ba+Sr+Ca)/(Ti+Zr+Hf) ) is less than 0.96 or the condition that ((Ba+Sr+Ca)/(Ti+Zr+Hf) ) is 1.02 or more, where the ratio of the numbers of atoms in the A site and the B site of the perovskite structure in the dielectric, that is, the A/B ratio is defined as ((Ba+Sr+Ca)/(Ti+Zr+Hf) ). In the dielectric having the perovskite structure with such an A/B ratio, when the first layer 19a is fired, the density of the first layer 19a can be increased to eliminate the density difference from the dielectric layers 15 due to a fine particle form without a large particle growth. In the second embodiment, it is preferable that an element for promoting particle growth is not added to the first layer 19a. When the first layer 19a is fired, excessive particle growth can be suppressed by setting the A/B ratio as described above, and as a result, dense particles can be formed, so that the density of the first layer 19a can be increased and the density difference from the dielectric layers 15 can be eliminated. Further, since there is no element for promoting the particle growth from the first layer 19a side and thus the diffusion of such the element into the dielectric layers 15 does not occur, the inhibition of the particle growth by the element diffused to the first layer 19a side of the dielectric layers 15, which occurs in the conventional art, is suppressed.

The ratio of the numbers of atoms in the A site and the B site of the perovskite structure in the dielectric, that is, the A/B ratio can be observed by using, for example, TEM-EDS (transmission electron microscopy-energy dispersive X-ray spectroscopy) for mapping the element to be measured. For the observation, a JEM-ARM200, manufactured by JEOL Ltd., or the like can be used.

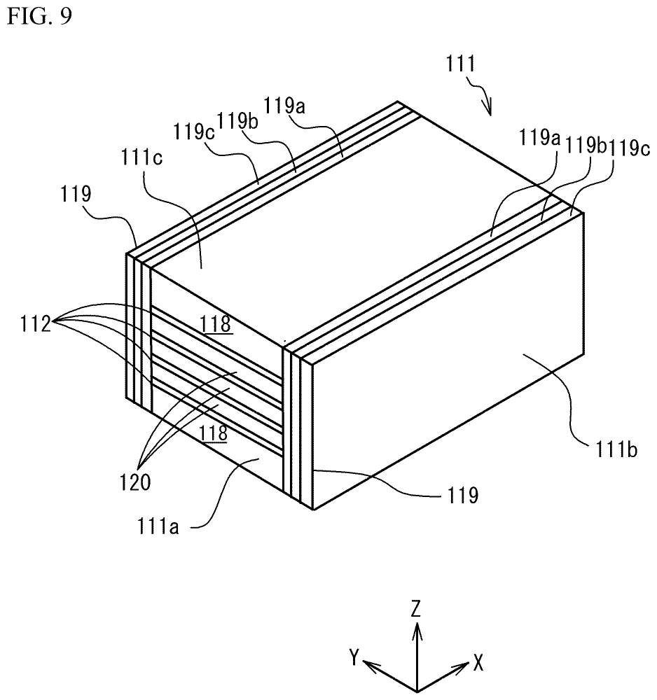

The first layer 19a may contain a Cu component. It is considered that the first layer 19a containing the Cu component improves the life of the multilayer ceramic capacitor 10. As described in detail later, the first layer 19a is formed by firing an unfired first layer 119a (see FIG. 9 and the like). It is considered that when the Cu component is diffused into the internal electrode layers 12 and 13 in contact with the unfired first layer 119a, the interface between the Ni contained in the internal electrode layers 12 and 13 and the dielectric of the capacitor section 16 is strengthened, and thereby the IR (Insulation Resistance) is improved. This is considered to improve the life of the multilayer ceramic capacitor 10. The Cu component may be, for example, CuO.

The first layer 19a is a dense layer. Thus, an average grain diameter of the grains forming the second layer 19b is smaller than an average grain diameter of the grains forming the second layer 19b, and is smaller than an average grain diameter of the grains forming the third layer 19c.

Regardless of the external size of the multilayer ceramic capacitor 10, the average grain diameter of the first layer 19a can be set to be larger than 0 μm and equal to or smaller than 5 μm. The average grain diameter of the second layer 19b may be set to be larger than 0 μm and equal to or smaller than 15 μm. The average grain diameter of the third layer 19c may be set to be larger than 0 μm and equal to or smaller than 30 μm. In a case of the multilayer ceramic capacitor 10 larger than 0603 size, for example, a combination in which the average grain diameter of the first layer 19a is larger than 0 μm and equal to or smaller than 7 μm, the average grain diameter of the second layer 19b is larger than 0 μm and equal to or smaller than 15 μm, and the average grain diameter of the third layer 19c is larger than 0 μm and equal to or smaller than 45 μm can be used. Additionally, a combination in which, for example, the average grain diameter of the first layer 19a is larger than 0 μm and equal to or smaller than 10 μm, the average grain diameter of the second layer 19b is larger than 0 μm and equal to or smaller than 20 μm, and the average grain diameter of the third layer 19c is larger than 0 μm and equal to or smaller than 60 μm can be used.

In any case, the average grain diameter of each layer is preferably as the following: the average grain diameter of the first layer 19a <the average grain diameter of the second layer 19b <the average grain diameter of the third layer 19c. Due to such a relationship of the average grain diameters, the structure which adheres to the capacitor portion, unlikely causes peeling between the respective layers, and has excellent reliability can be obtained.

The average grain size of each layer can be measured in the following manner. First, the multilayer ceramic capacitor 10 is subjected to cross-sectional polishing so that a surface including an axis in the lamination direction (first direction) can be observed. The observation is performed by a field emission secondary scanning electron microscope (FE-SEM) equipped with an energy dispersive X-ray spectrometer (EDS), and regions which are seen bright due to a contrast difference in this SEM image are specified as internal electrodes (the first internal electrode layers 12 or the second internal electrode layers 13), thereby specifying a region of the capacitor section 16 and specifying the outside as protective regions. An observation region is set in a dielectric region of protective regions which are outer portions perpendicular to the lamination direction of the capacitor section, and then EDS mapping is performed in this observation region to measure the presence of Ni, Ba, Ti, O, Mn, Mo, Yb, Er, Mg, Si, and other elements as necessary, and the present amount is calculated as atom % to the total composition at each point. The definitions of the first layer, the second layer and third layer allow the boundaries of each layer to be specified. For the measurement, FE-SEM (SU7000) manufactured by Hitachi High-Tech Corporation is usable as the field emission type scanning secondary electron microscope. As the EDS detector, Quantax manufactured by BRUKER Corporation is usable.

As for the measurement of the average grain diameters of the first layer 19a, the second layer 19b and the third layer 19c, the secondary electron image is used for setting the closest region of the capacitor section 16 side in the protective regions as the observation region of the first layer 19a, setting the most outside portion as the observation region of the third layer 19c, and selectively setting a portion with the highest content rate of Mn as the observation region of the second layer 19b, and then photographing three observation regions for each layer. In the average grain size measurement, the area of each grain in the field of view is measured by using image processing measurement software, calculating the diameter of a circle having an equal area (Heywood diameter), and further calculating the average value of them. The average value of the measured values at the three observation regions photographed by the SEM of can be used as the average grain diameter in each layer of the sample. The method of calculating the average grain diameter described here is just one example, and the average grain diameter may be calculated by another method.

The first layer 19a is formed as a dense film, thereby increasing a contact area with the dielectric layers 15 in the capacitor section 16, and thus the first layer 19a is easily adhered to the capacitor section 16.

The second layer 19b is an intermediate layer having a function of consistently connecting a layer in which the particle growth of the dielectric material on the first layer 19a side is suppressed and a layer in which the particle growth of the dielectric material on the first layer 19a side is promoted. The second layer 19b is characterized in that including a manganese (Mn) component and a glass component in the same main components as those of the dielectric layers 15. First, the Mn component contained in the second layer 19b is described below. The Mn component is a component that suppresses particle growth and increases the density in promoting the firing, and has a higher effect than Mg, Yb, and Er, which have similar effects. However, since the Mn component causes diffusion of elements in a wide range during firing, if the Mn component is added to the first layer 19a, the Mn component also diffuses into the adjacent dielectric layers 15, and suppresses particle growth of the dielectric on the first layer 19a side in the dielectric layers 15, thereby causing a decrease in capacitance value. Therefore, the Mn component is not suitable as an element to be added to the first layer 19a.

In the present invention, the Mn component is added to the second layer 19b sandwiching the first layer 19a with the dielectric layers 15. Even if the Mn component is diffused during the firing, the Mn component does not reach the dielectric material on the first layer 19a side of the dielectric layer 15 because the first layer 19a, which do not contain the Mn component before the firing, exhibits a buffer effect, and does not suppress the particle growth in this portion, so that the decrease in the capacitance value is not caused. The second layer 19b to which the Mn component with a densifying effect is added becomes a dense layer, and the first layer 19a in which the Mn component is diffused by the firing can be made a dense layer, compared with the case where the Mn component is not diffused, together with magnesium (Mg), ytterbium (Yb), and erbium (Er). Further, as described below, a sintering property is improved by the effect of the glass component contained in the second layer 19b, and the dielectric substance excessively grows, so that the density of the second layer 19b increases. Thus, the density difference from the first layer 19a, which suppresses the particle growth to reduce the density difference from the dielectric layers 15, is prevented from increasing, and the mechanical strength becomes discontinuous, and peeling and cracking can be prevented from occurring.

The content of the Mn component in the second layer 19b is larger than that in the first layer 19a. Here, the content of the Mn component can be compared by the atomic ratio of Mn in each layer. That is, the atomic ratio of Mn in the second layer 19b is larger than that in the first layer 19a. The first layer 19a may contain the Mn component. The content of the Mn component in the first layer 19a is 0% or more and 100% or less of the content of the Mn component in the second layer 19b. Since the content of the Mn component in the first layer 19a is 0% or more of the content of the Mn component in the second layer 19b, the first layer 19a may not contain the Mn component. The comparison of the content may be expressed by the concentration distribution of each component.

The content and concentration of each element component can be measured as follows. The observation surface of the multilayer ceramic capacitor 10 exposed by the cross-sectional polishing so that the surface including the axis in the lamination direction (first direction) is observed by a field emission secondary scanning electron microscope (FE-SEM) equipped with an energy dispersive X-ray spectrometer (EDS), and regions which are seen bright due to a contrast difference in this SEM image are specified as internal electrodes (the first internal electrode layers 12 or the second internal electrode layers 13), thereby specifying a region of the capacitor section 16 and specifying the outside as protective regions. An observation region is set in the dielectric region of protective regions which are outer portions perpendicular to the lamination direction of the capacitor section, and then EDS mapping is performed in this observation region to measure the presence of Ni, Ba, Ti, O, Mn, Mo, Yb, Er, Mg, Si, and other elements as necessary, and the present amount is calculated as atom % to the total composition at each point. The definitions of the first layer, the second layer and third layer allow the boundaries of each layer to be specified. The average of the observed areas at three locations in each layer can be used as the average content and the average concentration of the layer. The observation region may be the same as the observation region set for the measurement of the average grain diameter. For the measurement, FE-SEM (SU7000) manufactured by Hitachi High-Tech Corporation is usable as the field emission type scanning secondary electron microscope. As the EDS detector, Quantax manufactured by BRUKER Corporation is usable.

In the first layer 19a, there may be a concern that the grain diameter of the dielectric ceramic in the element body 11 is reduced by the diffusion of the Mn component into the element body 11, and the effective capacitance is lowered. Therefore, it is preferable that the amount of the Mn component in the first layer 19a is reduced so that the Mn component does not diffuse into the element body 11. On the other hand, it is assumed that the particle growth in the vicinity of the element body 11 causes a decrease in the life, for example, as a result of the HALT (Highly Accelerated Limit Test) test. Therefore, it is preferable that the second layer 19b contains an appropriate amount of Mn component specifically for allowing the diffusion of Mn from the second layer 19b only to the first layer 19a and suppressing the particle growth so as not to diffuse Mn to the element body 11, as the diffusion is not involved in the particle growth of the dielectric ceramics of the element body 11. That is, the concentration gradient of the Mn component is preferably set to satisfy the relationship of the concentration of the first layer 19a<the concentration of the second layer 19b. The content of the Mn component in the first layer 19a is preferably 80% or less, more preferably 60% or less, and much more preferably 30% or less of the content of the Mn component in the second layer 19b.

Next, the glass component contained in the second layer 19b is described. The glass component may be any component having a low melting point that forms a liquid phase during the firing of the element body 11, and may include, for example, silicon and boron. The presence of each element component can be identified and the concentration thereof can be measured in the same manner as the measurement of the Mn component. At this time, a portion where silicon and boron, which are elements contained in the glass, are simultaneously observed at the same observation point is identified as a portion where the glass exists. The concentration of the glass component is defined as the total concentration of silicon and boron. In the second layer 19b, the liquid phase composed of the glass component is discharged from the crystal particles during the firing, and thus becomes a microstructure where the glass phase is segregated at the crystal particle boundaries.

In the second layer 19b in which the glass phase is precipitated at the particle boundaries, a high sintering property can be obtained by the formation of the liquid phase during the firing, and a structure with few voids between the grains can be obtained. Since the Mn component and the glass are present in the second layer 19b at the same time, the grains in which the particle growth is suppressed are densely arranged, and the layer can be formed with a small number of voids among the grains. This makes it possible to provide a highly reliable structure that prevents moisture and the like from infiltrating.

The third layer 19c is a layer in which the particle growth of the dielectric is promoted. Since the first layer 19a and the second layer 19b are sandwiched between the dielectric layer 15 and the third layer 19c, the particle growth of the dielectric in the third layer 19c is possible without affecting the dielectric in the dielectric layer 15. The third layer 19c is a layer having a function of improving moisture resistance. The glass component is also included in the third layer 19c. The glass component contained in the third layer 19c may be any component having a low melting point that forms a liquid phase during the firing of the element body 11, and may include, for example, silicon, boron, or the like. The content of the glass component in the second layer 19b is larger than the content of the glass component in the third layer 19c. By making the content of the glass component in the second layer 19b larger than the content of the glass component in the third layer 19c, the glass component diffused during the firing from the second layer 19b is diffused into the third layer 19c. The third layer 19c may contain a small amount of glass component in advance before the firing. The glass component contained in advance in the third layer 19c may be the same as or different from the glass component contained in the second layer 19b. The glass component is liquid-phased during the firing to form a dielectric layer with few voids (pores). Further, the glass component that is liquidized and diffused enters even a small amount of the generated voids (pores) and is cooled after the firing, thereby filling the voids (pores) in the third layer 19c. This improves the moisture resistance of the third layer 19c. Since the third layer 19c is the outermost layer of the side margin 19, the moisture resistance of the multilayer ceramic capacitor 10 is ameliorated by improving the moisture resistance of the third layer 19c.

An element for promoting the particle growth can be added to the third layer 19c. The element that promotes the particle growth is not an element, among elements promoting the firing, that promotes densification, but an element that causes particle growth such that a plurality of the particles is grown into a unified particle. As the element promoting the particle growth, molybdenum (Mo), boron (B), silicon (Si), and the like can be usable. It is preferable that the element causing the particle growth is not contained in the first layer 19a and the second layer 19b before the firing. This is because the elements that cause the particle growth do not diffuse into the dielectric layer 15 because the first layer 19a and the second layer 19b serve as buffers, even if they diffuse during the firing, and do not affect the capacitance. The content of the element promoting the particle growth in each layer after the firing satisfies the relationship of first layer 19a <second layer 19b <third layer 19c. The element added to the third layer 19c for promoting the particle growth can improve the reliability as well as the glass component.

The thickness of each layer can be set to the following exemplary dimensions, for example, when the size of the multilayer ceramic capacitor 10 is 0603 size (0.6 mm×0.3 mm×0.3mm). The thickness t [19a] of the first layer 19a may be greater than 0 μm and equal to or less than 10 μm. The thickness t [19b] of the second layer 19b may be set to be greater than 0 μm and equal to or less than 20 μm. The thickness t [19c] of the third layer 19c may be set to be greater than 0 μm and equal to or less than 60 μm. The thickness of each layer is a dimension along the Y-axis direction. The thickness of each layer is appropriately changed according to the size of the multilayer ceramic capacitor 10, and can be set to satisfy the relationship of the thickness t [19a] of the first layer 19a<the thickness t [19b] of the second layer 19b<the thickness t [19c] of the third layer 19c. The comparison of the thicknesses of each layer may be a comparison between the maximum thicknesses or between the average thicknesses. The relationship between the thickness of each layer can be derived from the average grain diameter of the grains constituting each layer and the number of grains required for each layer. When each layer is composed of a single grain layer, the layer tends to have many paths through which water or the like can infilter. Therefore, it is preferable that two to five grains constitute the thickness of each layer, and considering continuity of mechanical strength such as peeling between layers, it is more preferable that three to five grains constitute the thickness of each layer.

Each of the external electrodes 14a and 14b have a base film 21 formed so as to cover the surface of the protective region 17 from which the internal electrode layers 12 and 13 are drawn, and a plating film 22 formed on the base film 21. In FIGS. 1 to 3, the base film 21 is formed so as to cover the end surface 11a, and the plating film 22 is formed on the base film 21. The base film 21 is formed of, for example, a baked film obtained by baking a conductive paste, a sputtered film, or the like. The plating film 22 is a film formed by electrolytic plating. The films of the external electrodes 14a and 14b are formed of, for example, a metal or an alloy containing nickel (Ni), copper (Cu), tin (Sn), palladium (Pd), platinum (Pt), silver (Ag), gold (Au), or the like as a main component.

### Manufacturing Method of the Multilayer Ceramic Capacitor 10

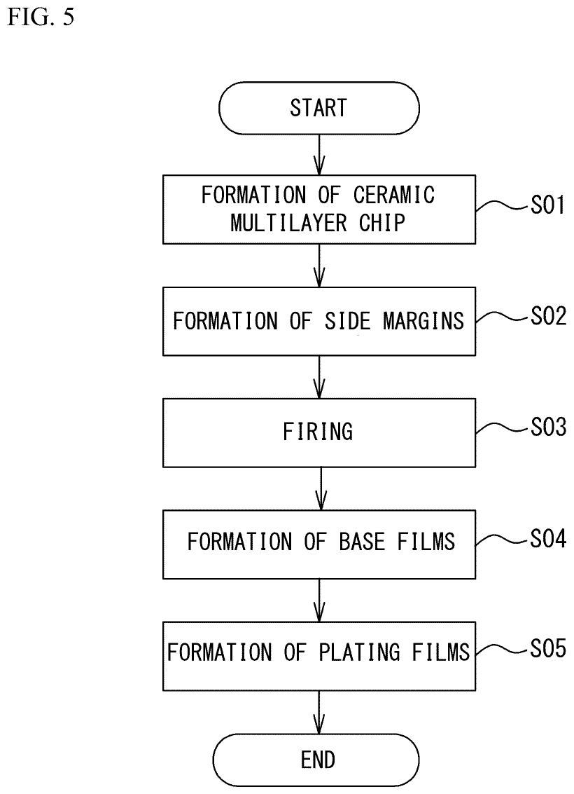

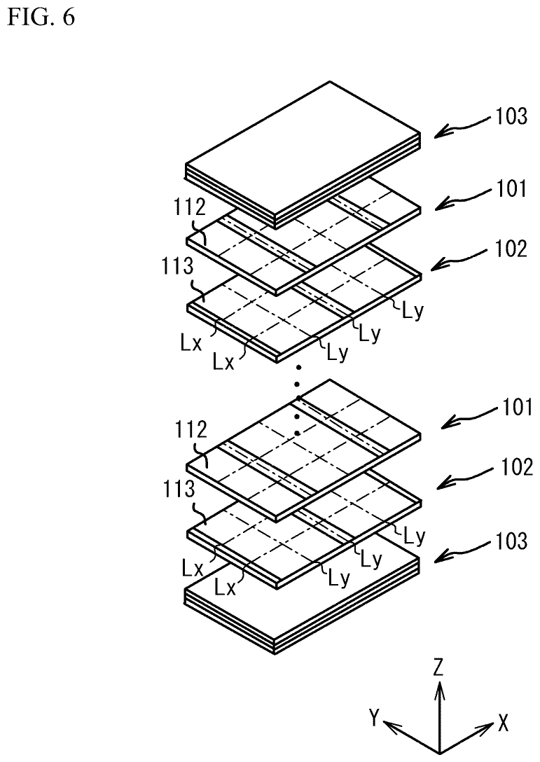

FIG. 5 is a flowchart illustrating the manufacturing method of the multilayer ceramic capacitor 10. FIGS. 6 to 9 are schematic views illustrating a manufacturing process of the multilayer ceramic capacitor 10. Hereinafter, the manufacturing method of the multilayer ceramic capacitor 10 is described according to the flowchart in FIG. 5 appropriately referring to FIGS. 6 to 9.

### (Step S01: Formation of Ceramic Multilayer Chip C)

In the step 01, an unfired ceramic multilayer chip (a laminated chip) C is formed by laminating ceramic sheets 101 and 102 for forming the capacitor section 16 and ceramic sheets 103 for forming the cover portions 18, and then cutting the laminate.

Prior to the formation of the ceramic multilayer chip C, a dielectric material is prepared. The A-site element and the B-site element contained in the dielectric layers 15 are usually contained as the form of a sintered body of ABO₃ grains in the dielectric layers 15. For example, barium titanate is a tetragonal compound with a perovskite structure and has a high relative permittivity. This barium titanate can be generally obtained by reacting a titanium raw material such as titanium dioxide with a barium raw material such as barium carbonate for synthesis. As a method for synthesizing the main component ceramic of the dielectric layers 15, various methods are known such as, for example, a solid phase method, a sol-gel method, a hydrothermal method, and the like. In the present embodiment, any of these can be adopted.

A predetermined additive compound applicable to the purpose is added to the obtained ceramic raw material powder. The additive compounds include an oxide of zirconium (Zr), magnesium (Mg), manganese (Mn), molybdenum (Mo), vanadium (V), chromium (Cr), a rare earth element (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm) and ytterbium (Yb)), an oxide including cobalt (Co), nickel (Ni), lithium (Li), boron (B), sodium (Na), potassium (K) or silicon (Si), or a glass including cobalt, nickel, lithium, boron, sodium, potassium or silicon.

For example, the ceramic material is prepared by wet-mixing a compound containing the additive compound with the ceramic raw material powder, followed by drying and grinding. For example, the ceramic material obtained as described above may be, if necessary, subjected to a grinding treatment to adjust the grain diameter or in combination with a classification treatment adjust the grain diameter. Through the above steps, the dielectric material is obtained.

The ceramic sheets 101, 102 and 103 in FIG. 6 are configured as unfired dielectric green sheets containing a dielectric material made of a dielectric ceramic, an organic binder, and other additives. The ceramic sheet 101 is formed with unfired first internal electrode patterns 112 corresponding to the first internal electrode layers 12. The ceramic sheet 102 is formed with unfired second internal electrode patterns 113 corresponding to the second internal electrode layers 13. No internal electrode is formed on the ceramic sheets 103. Additionally, the ceramic sheets 101, 102 and 103 can be obtained in the following manner. A binder such as polyvinyl butyral (PVB) resin, an organic solvent such as ethanol or toluene, and a plasticizer are added to the obtained raw material powder and wet mixed. A ceramic green sheet 51 is coated on a substrate by, for example, a die coater method or a doctor blade method using the obtained slurry, and dried. The substrate is, for example, a polyethylene terephthalate (PET) film.

The first internal electrode layers 12 and the second internal electrode layers 13 are mainly composed of a base metal such as nickel (Ni), copper (Cu), or tin (Sn), or an alloy containing these metals. Noble metals such as platinum (Pt), palladium (Pd), silver (Ag), and gold (Au), and alloys containing these metals may be used. Thus, a metal conductive paste for forming internal electrodes containing these materials and an organic binder is prepared. The internal electrode patterns 112 and 113 have a plurality of band-shaped electrode patterns which cross cutting lines Lx parallel to the X-axis direction and extend along cutting lines Ly parallel to the Y-axis direction. These internal electrode patterns 112 and 113 are formed by printing with the metal conductive paste according to screen printing, gravure printing, or the like. The method of forming the internal electrodes is not limited to printing, and plating, vacuum evaporation, sputtering, or CVD may be used.

The ceramic sheets 101 and 102 are alternately laminated in the Z-axis direction as illustrated in FIG. 6. The laminate of the ceramic sheets 101 and 102 correspond to the capacitor section 16 and the end margins 20. The ceramic sheets 103 are laminated on the upper and lower surfaces in the Z-axis direction of the unfired laminate of the ceramic sheets 101 and 102. The multilayer body of the ceramic sheets 103 corresponds to the cover portions 18. The numbers or the like of ceramic sheets 101, 102 and 103 to be laminated can be appropriately adjusted.

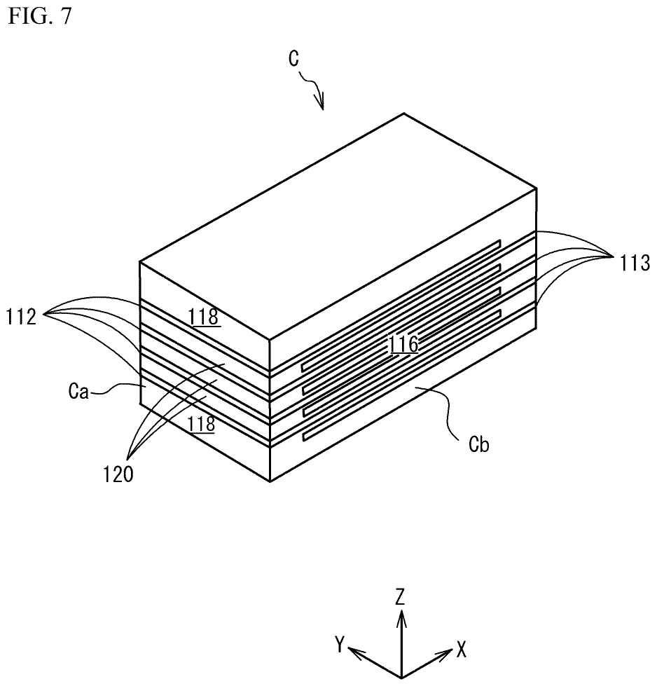

Subsequently, the multilayer body of the ceramic sheets 101, 102 and 103 is pressed in the Z-axis direction and cut along the cutting lines Lx and Ly. Thus, the multilayer chip C illustrated in FIG. 7 is formed.

The multilayer chip C has an unfired capacitor section 116 on which the unfired internal electrode patterns 112 and 113 are formed, an unfired cover portion 118, and unfired end margins 120. A side surface Cb which is a cut surface corresponding to the cutting line Lx and an end surface Ca which is a cut surface corresponding to the cut line Ly are formed on the multilayer chip C. The end portions of the unfired internal electrode patterns 112 and 113 are exposed from the side surface Cb.

### (Step 02: Formation of Side Margins 119)

In the step 02, the side margins 119 are formed on the side surfaces Cb of the multilayer chip C. An example of the forming method is described below.

The side margin 119 includes the unfired first layer 119a, an unfired second layer 119b and an unfired third layer 119c. In this embodiment, the first layer 119a, the second layer 119b and the third layer 119c are sequentially formed on each of the side surface Cb by the paste dip method. In the present embodiment, the binder removal process of the multilayer chip C may be completed before the formation of the side margins 119. By completing the binder removal treatment, the sheet or paste to form the protective regions enters the portion from which the binder is removed. This improves the adhesion strength of each layer. The binder removal treatment can be performed before the firing (step S03) described below or simultaneously in the firing (step S03).

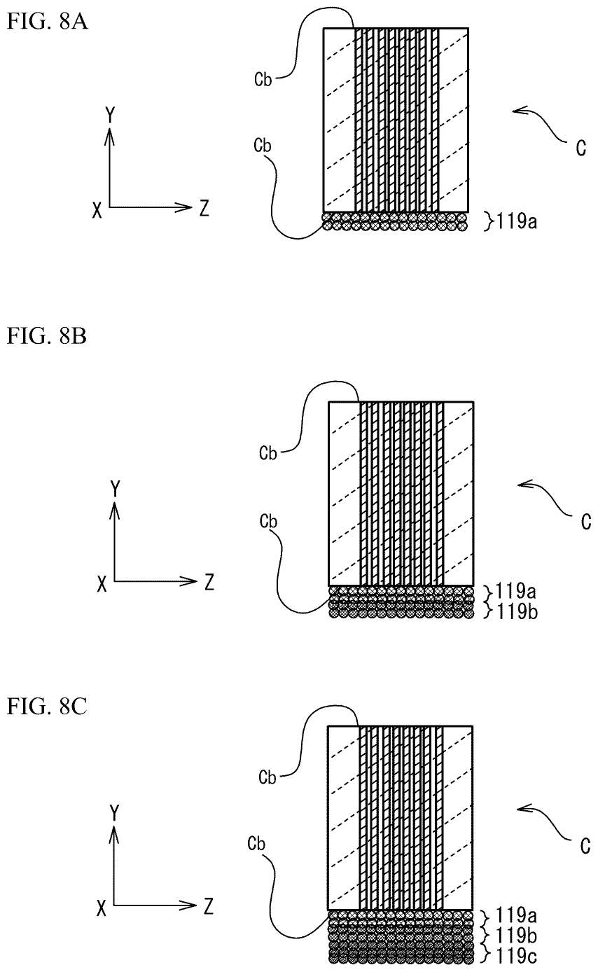

First, as illustrated in FIG. 8A, the first layer 119a is formed on one side surface Cb. Next, as illustrated in FIG. 8B, the second layer 119b is formed so as to cover the first layer 119a. Then, as illustrated in FIG. 8C, the third layer 119c is formed so as to cover the second layer 119b.

After the first layer 119a, the second layer 119b and the third layer 119c are formed on the one side surface Cb, the first layer 119a, the second layer 119b and the third layer 119c are formed on the other side surface Cb in the same manner. Thus, an unfired ceramic element body 111 illustrated in FIG. 9 is formed.

Further, the first layers 119a, the second layers 119b, and the third layers 119c may be formed by attaching ceramic sheets to each other.

The first layer 119a has a ceramic material made of a dielectric ceramic as a main component and contains at least one element selected from Mg, Yb, and Er and other additives, but does not contain Mn. The second layer 119b has a ceramic material made of a dielectric ceramic as a main component and contains an Mn component, a glass component, and other additives. The third layer 119c has a ceramic material made of a dielectric ceramic as a main component and contains a glass component and other additives such as Mo, BN, and Si. The first layer 119a, the second layer 119b, and the third layer 119c all contain a binder. The first layer 119a does not contain Mn components before the firing. In this case, in the concentration gradient of the Mn component after the firing, the relationship of the first layer 119a<the second layer 119b is satisfied.

### (Step S03: Firing)

In the step 03, the ceramic element body 111 obtained in the step 02 is fired to form the element body 11 of the multilayer ceramic capacitor 10 illustrated in FIG. 1. The firing temperature in the step 03 can be determined based on the sintering temperature of the ceramic element body 111. The firing can be performed, for example, in a reducing atmosphere or in an atmosphere having a low oxygen partial pressure. For example, the firing is performed for 5 minutes to 10 hours in the reducing atmosphere with an oxygen partial pressure of 10-5 to 10-8 atm at a temperature range of 1100° C. to 1300° C.

Although one or more elements of Mg, Yb, and Er contained in the first layer 119a promote densification, the one or more elements are difficult to diffuse during the firing and thus do not affect the particle growth of the dielectric in the multilayer chip C. Also, Mn is a densifying component and is a component that is easily diffused during the firing, but since Mn is not contained in the first layer 119a, the particle growth of the dielectric in the multilayer chip C is not affected. This does not inhibit the particle growth of the dielectric of the multilayer chip C adjacent to the first layer 119a. As a result, the effective capacitance of the capacitor section 16 formed after the firing is secured.

The second layer 119b contains Mn. Although Mn is diffused toward the multilayer chip C, it is difficult for Mn to reach the multilayer chip C because the first layer 119a is interposed between the multilayer chip C and the second layer 119b. As a result, the effective capacitance of the capacitor section 16 formed after the firing is secured. Additionally, the second layer 119b contains a glass component. The glass component is difficult to diffuse into the first layer 119a which becomes a dense layer. Therefore, the glass component is mainly diffused in the third layer 119c. The glass component diffused in the third layer 119c fills the voids (pores) in the third layer 119c. This makes it possible to densify the third layer 119c and improve the moisture resistance.

### (Step S04: Formation of Base Films)

In the step 04, a conductive base film 21 is formed on the end surfaces 11a, the side surfaces 11b and the main surfaces 11c illustrated in FIGS. 2 and 3.

The base film 21 is formed by applying an unfired electrode material to the end surfaces 11a, the side surfaces 11b and the main surfaces 11c. The coating method is, for example, a dip method, but may be other methods known in the art, including a printing method, a sputtering method, and a combined method of these methods. Subsequently, the unbaked electrode material is baked. The baking can be performed, for example, in a reducing atmosphere or in a low oxygen partial pressure atmosphere.

### (Step S05: Formation of Plating Film)

In the step S05, the multilayer ceramic capacitor 10 having the base films 21 formed thereon is immersed in a plating solution for forming the plating films 22, and electrolytic plating is performed. Thus, the plating film 22 is formed.

In this way, the multilayer ceramic capacitor 10 illustrated in FIGS. 1 to 3 is manufactured.

In the formation of the side margins 119 in the step 02, when a ceramic material made of a dielectric ceramic to form the first layer 119a is prepared, a dielectric material containing no element of one or more of Mg, Yb, and Er and containing no Mn may be prepared and used. Other steps may be the same as those in the case where one or more elements of Mg, Yb, and Er are contained. That is, when the ratio of the numbers of atoms in the A site and the B site of the perovskite structure in the dielectric, that is, the A/B ratio of the first layer 119a is defined as ((Ba+Sr+Ca)/(Ti+Zr+Hf)), the first layer 119a like that can be formed by the preparation either in the condition that the ((Ba+Sr+Ca)/(Ti+Zr+Hf)) is less than 0.96 or a condition that the ((Ba+Sr+Ca)/(Ti+Zr+Hf)) is 1.02 or more is satisfied as the ratio in the layer. In this case, the influence of Mn contained in the second layer 119b on the capacitor section can be eliminated, and the multilayer ceramic capacitor 10 with excellent adhesion to the capacitor section can be obtained due to the dense first layer 119a.

### Second Embodiment

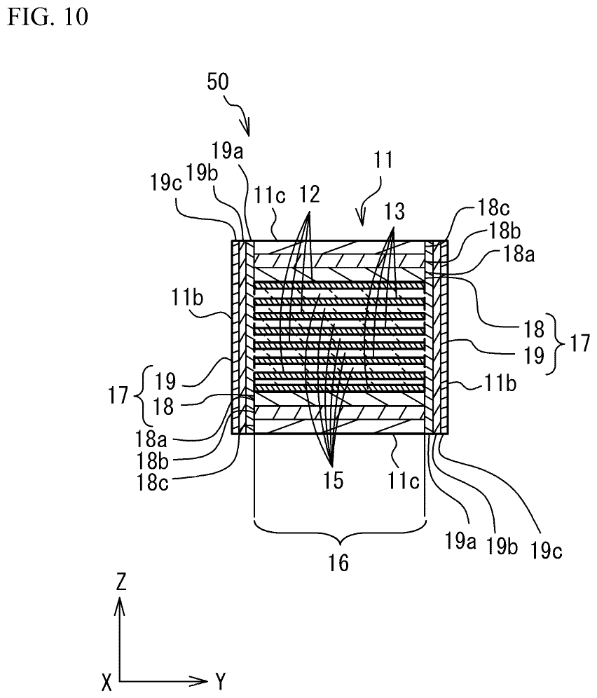

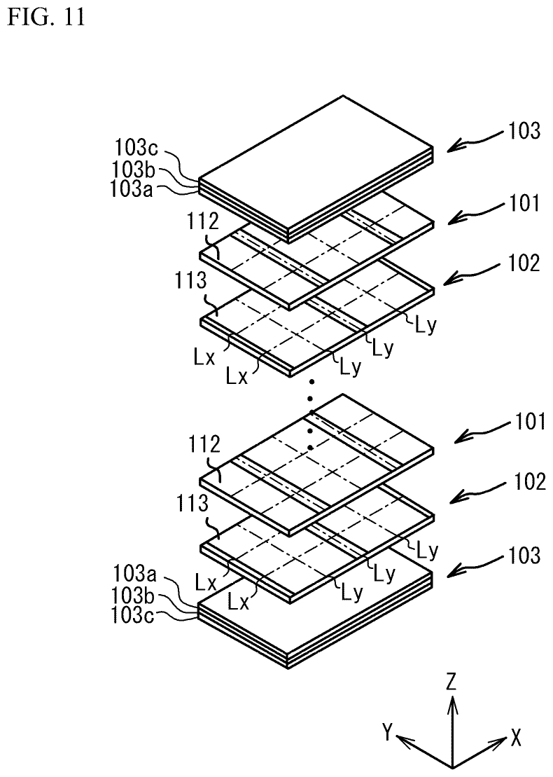

Next, a multilayer ceramic capacitor 50 of the second embodiment is described. FIG. 10 is a sectional view of the multilayer ceramic capacitor 50 of the second embodiment cut along a cutting line corresponding to the line A-A ′ in FIG. 1. FIG. 11 is a schematic sectional view of the multilayer ceramic capacitor 50 of the second embodiment in progress of a manufacturing process.

Referring to FIG. 10, the cover portions 18 included in the protective regions 17 include a first layer 18a, a second layer 18b, and a third layer 18c. That is, the multilayer ceramic capacitor 50 of the second embodiment includes the cover portions 18 having a three-layered structure like the side margins 19. Each components forming the first layer 18a, the second layer 18b, and the third layer 18c included in the cover portions 18 are identical to each components forming the first layer 19a, the second layer 19b, and the third layer 19c included in the side margins 19. Therefore, the first layer 18a, the second layer 18b, and the third layer 18c included in the cover portions 18 have the same functions as those of the first layer 19a, the second layer 19b, and the third layer 19c included in the side margins 19 respectively.

As illustrated in FIG. 11, the ceramic sheet 103 to form the first layer 18a, the second layer 18b, and the third layer 18c are formed by laminating ceramic sheets 103a, 103b and 103c. The ceramic sheet 103a corresponds to the first layer 18a. The ceramic sheet 103b corresponds to the second layer 18b. The ceramic sheet 103c corresponds to the third layer 18c.

Thereafter, the same steps as those in the first embodiment are performed to obtain the multilayer ceramic capacitor 50 of the second embodiment.

The present invention is not limited to the specific embodiments described above, and various modifications and changes are possible within the scope of the gist of the present invention.

The multilayer ceramic capacitor 10 is an example of the multilayer ceramic electronic component in the above embodiment, but the present invention is applicable to various multilayer ceramic electronic components in which dielectric layers and an internal electrodes are laminated. Examples of such a multilayer ceramic electronic component include a chip varistor and a chip thermistor.

What is claimed is:

1. A multilayer ceramic electronic component comprising:
an element body having a substantially rectangular parallelepiped shape, the element body including a capacitor section in which first internal electrode layers and second internal electrode layers are alternately laminated with a dielectric layer interposed therebetween and protective regions provided outside of the capacitor section; and
external electrodes provided on surfaces of the element body respectively so as to be spaced from each other, the first internal electrode layers and the second internal electrode layers being respectively drawn out from the surfaces,
wherein each of the dielectric layer and the protective regions contains a dielectric ceramic as a main component,
each of the protective regions includes a first layer adjacent to the capacitor section, a second layer adjacent to the first layer, and a third layer adjacent to the second layer, the first layer, the second layer, and the third layer being sequentially disposed on the capacitor section,
an atomic ratio of Mn in the second layer is larger than that in the first layer, and
a content of a glass component of the second layer is larger than that of the first layer and that of the third layer.

2. The multilayer ceramic electronic component according to claim 1, wherein
the first layer contains at least one element selected from Mg, Yb, or Er, and
a total content of the at least one element is larger than a content of Mn in the first layer.

3. The multilayer ceramic electronic component according to claim 1, wherein
a content of Mn in the second layer is higher than a total content of Mg, Yb, and Er in the second layer.

4. The multilayer ceramic electronic component according to claim 1, wherein
the third layer contains at least one element selected from Mo, B, or Si, and a total content of the at least one element in the third layer is larger than a content of Mn in the third layer.

5. The multilayer ceramic electronic component according to claim 1, wherein
a content of components of the first layer is 0% or more and 100% or less of a content of components of the second layer.

6. The multilayer ceramic electronic component according to claim 1, wherein
the first layer contains a Cu component.

7. The multilayer ceramic electronic component according to claim 1, wherein
when an A/B ratio, which is a ratio of the numbers of atoms in an A site and a B site of a perovskite structure of a dielectric material of the first layer, is defined as ((Ba+Sr+Ca)/(Ti+Zr+Hf)), a condition that the ((Ba+Sr+Ca)/(Ti+Zr+Hf)) is less than 0.96 or a condition that the ((Ba+Sr+Ca)/(Ti+Zr+Hf)) is 1.02 or more is satisfied.

8. The multilayer ceramic electronic component according to claim 1, wherein
the protective regions include at least one of side margins and cover portions.

9. A manufacturing method of a multilayer ceramic electronic component, comprising:
forming a multilayer body as a capacitor section in which first internal electrode layers and second internal electrode layers are alternately laminated with a dielectric layer interposed therebetween;
forming an element body by providing the multilayer body with protective regions having a first layer adjacent to surfaces of the multilayer body where the first internal electrode layers and the second internal electrode layers are exposed, a second layer adjacent to the first layer, and a third layer adjacent to the second layer;
firing the element body;
forming external electrodes on the element body after the firing,
wherein each of the dielectric layer and the protective regions contains a dielectric ceramic as a main component,
an atomic ratio of Mn in the second layer is larger than that in the first layer, and
a content of a glass component of the second layer is larger than that of the first layer and that of the third layer.
